(19) United States
(12) Patent Application Publication
(10) Pub. No.: US 2014/0035316 A1
(43) Pub. Date: Feb. 6, 2014

(54) VEHICLE CENTERLINE FAIRING SYSTEM

(71) Applicant: AEROFFICIENT LLC, Livonia, MI (US)

(72) Inventor: JAMES REIMAN, Evanston, IL (US)

(73) Assignee: AEROFFICIENT LLC, Livonia, MI (US)

(21) Appl. No.: 13/959,740

(22) Filed: Aug. 6, 2013

Related U.S. Application Data
(60) Provisional application No. 61/679,995, filed on Aug. 6, 2012.

(51) Int. Cl. B62D 35/00

(52) U.S. Cl. CPC B62D 35/002
USPC 296/180.4

(57) ABSTRACT

A van trailer or intermodal chassis having a centerline fairing.

### BACKGROUND OF THE INVENTION

1. Field of the Invention

This invention relates to a system for improving the aerodynamic profile of vehicles by utilizing vehicle fairing structures, especially for use on an intermodal chassis used to transport intermodal shipping containers by road (“Chassis” or “Chasses”). Additionally, the system can be employed on any trailer used in a tractor-trailer combined vehicle (“Truck”). The system improves fuel consumption without having a material adverse impact on operation or service procedures pertinent to the Truck.

2. Description of the Related Art

The amount of power needed to move a vehicle over land or through the air increases with the speed of the vehicle due to aerodynamic drag. The amount of power necessary to overcome aerodynamic drag directly translates into increased fuel consumption, and thus increased emission of greenhouse gases and pollutants, and increased cost of operation.

A variety of innovations aimed at reducing the aerodynamic drag of various transport vehicles, including tractor-trailer combinations, have been proposed and/or introduced. These include efforts to make the hood, windscreen, fenders, etc. more streamlined in form, as well as by adding fairings to the cab roof, and in some cases, to the trailer when the trailer is a “box” van or refrigerated heavy duty truck trailers. Hereinafter standard van and refrigerated “box” heavy duty truck trailers shall be referred to as “Van Trailer(s)”.

U.S. Pat. No. 6,799,791 discloses a vehicle fairing structure that can be deployed on the rear of a Van Trailer box to reduce drag at the rear end of the Van Trailer box. Since a significant amount of drag is also associated with the front of the Van Trailer box, where there is known to be an area of high pressure and relatively stagnant air approximately at the middle of the forward vertical face of the trailer cab, a front fairing structure for reducing this drag is disclosed in U.S. Pat. No. 7,604,284.

It is also the case that significant drag results from air entering under the Van Trailer, between the box and the road surface. Systems that include side fairings to reduce such drag are disclosed in U.S. Pat. No. 7,404,592, U.S. patent application Ser. No. 12/185,468, filed Aug. 4, 2008; U.S. Pat. No. 7,942,466, issued May 17, 2011; and PCT Application No. PCT/US2011/023728, filed Feb. 4, 2011. The foregoing patents and applications (The disclosures of U.S. Pat. No. 7,404,592, U.S. Pat. No. 7,942,466, U.S. patent application Ser. No. 12/185,468 and PCT Application No. PCT/US2011/023728) are incorporated herein by reference.

While the foregoing side fairing systems are suitable for Van Trailer boxes, a significant amount of freight is moved using intermodal systems. In such systems, the trailer box is a separate component from the Chassis, so that multiple boxes (referred to as containers) can be stacked on container ships or flatbed railcars and single containers can be mounted on trailers for transit by Truck. When the containers are moved between their originating/final destinations by road or Truck, Chasses specially designed to accommodate the container are utilized. A crane or a forklift is typically used to lift a container onto and off of the Chassis.

Utilizing a side fairing in an intermodal application to reduce aerodynamic drag is challenging, because the design needs to take into account the foregoing modes of operation. To permit easier movement and stacking of containers, it may be desirable to secure the fairing to the Chassis rather than the container. However, any fairing design must take into consideration that the container may be lowered onto the Chassis in a tilted or otherwise imperfect orientation, thereby striking the fairing.

Intermodal containers are typically made of steel and are of robust, heavy construction so that they can withstand the rigors of being moved multiple times while securely protecting and supporting the freight that they carry. As a consequence, there is risk of damage to any side fairing mounted on the Chassis should the container be lowered onto the Chassis in any imperfect orientation. Perfect lifting/lower and perfect alignment of the container to the Chassis cannot always be achieved. One solution to this problem is disclosed in U.S. patent application Ser. No. 13/526,280, filed Jun. 18, 2012.

Still further, there are intermodal Chasses that can be extended and reduced in length in order to accommodate containers of differing sizes. The bogie wheels may also be adjustable in the fore and aft direction in order to accommodate different container weights and cargo distribution. A drag reducing fairing for an intermodal Chassis ideally should take into account these characteristics.

### SUMMARY OF THE INVENTION

The present invention in one embodiment is a Chassis having one or more generally longitudinal structural beams and bogie wheels attached thereto, either directly, or indirectly via a bogie wheel mounting assembly. The longitudinal beam(s) are generally oriented in the direction of travel, and the Chassis when placed on a road surface defines a spatial gap forward of the bogie wheels between the road surface and the bottom of an intermodal container to be carried by the Chassis. The structural beams each comprise a forward portion and a rearward portion. On some Chasses, the rearward and forward portions have a telescoping relationship, so that the Chassis has an extendible length. On other Chasses, the forward and rearward portions are fixed (non-telescoping); however, the bogie wheels on the Chassis can be moved forward/rearward.

In this embodiment, there is provided a centerline fairing secured at a position on or near the longitudinal centerline of the Chassis, proximate to the gap. The centerline fairing comprises a first fairing panel and a second fairing panel, with the panels longitudinally juxtapositioned to function aerodynamically as a single panel. A portion of the first fairing panel is secured to the forward portion of the structural beams, and a portion of the second fairing panel is secured to the rearward portion of the structural beams. The trailing edge of the first fairing panel is located approximately at the leading edge of the second fairing panel, or overlaps it in the longitudinal direction (the direction of travel).

In the case of a Chassis with rearward and forward portions having a telescoping relationship, an overlapping relationship is maintained as the Chassis' structural beams are telescoped inwardly and extended outwardly. Regardless of the amount of extension, the fairing panels of the centerline fairing generally function as a single panel, meaning that given their juxtaposed relationship they exhibit aerodynamic characteristics, as relevant here, generally the same as a single panel. That is, the fairing panels of the centerline fairing act to reduce cross-winds and airflow passing underneath the Chassis, which would otherwise cause deleterious aerodynamic drag, in substantially the same manner, and to substantially the same degree, as a single panel.

The foregoing embodiment can also be utilized on Chasses with fixed structural beams but moving bogies by securing the second fairing panel to the bogies rather than the structural beams of the Chassis. Additionally, this embodiment may be used on Van Trailers with bogies which move foreward/rearward, or on Chasses which have both telescoping structural beams and bogies which move forward/rearward.

Two, three, or more fairing panels may be used in the foregoing embodiment, depending upon the particular Chassis and other design considerations Likewise, each fairing panel can actually comprise a group of two or more panels, juxtaposed to act as a single panel.

In another embodiment of the present invention, there is a Van Trailer or Chassis comprising one or more generally longitudinal structural beams and bogie wheels attached thereto, either directly, or indirectly via a bogie wheel mounting assembly. The longitudinal beam(s) are generally oriented in the direction of travel, and the Van Trailer or Chassis when placed on a road surface defines a spatial gap forward of the bogie wheels between the road surface and the bottom of the Van Trailer or an intermodal container to be carried by the Chassis. There is provided a centerline fairing secured at a position on or near the longitudinal centerline of the Van Trailer or Chassis, proximate to the gap, and the centerline fairing has a trailing edge.

Further, in this embodiment the centerline fairing comprises one or more longitudinally positioned generally planar panels that are juxtapositioned to function aerodynamically as a single panel, and there is provided a vee-fairing having an apex, the vee-fairing having a first section and a second section, each section comprising one or more generally planar panels and each section oriented relative to the other to form a vee, the vee-fairing secured forward of the bogie wheel mounting assembly, where the apex of the vee-fairing is proximate to the trailing edge of the centerline fairing.

In a further embodiment of the present invention, a Van Trailer or Chassis comprises one or more generally longitudinal structural beams and bogie wheels attached thereto via a bogie wheel mounting assembly (in the case where this embodiment uses a Chassis, the Chassis can be either of fixed length or telescoping). The longitudinal beam(s) are generally oriented in the direction of travel, and the Van Trailer or Chassis when placed on a road surface defines a spatial gap forward of the bogie wheels between the road surface and the bottom of the Van Trailer or an intermodal container to be carried by the Chassis. The bogie wheel mounting assembly is fore and aft adjustable. There is provided a centerline fairing comprised of one or more panels secured at a position on or near the longitudinal centerline of the Van Trailer or Chassis, proximate to such gap. The centerline fairing has a trailing edge.

There is further provided a vee-fairing having an apex, the vee-fairing having a first section and a second section, each section comprising of one or more generally planar panels and each section oriented relative to the other to form a vee, with the vee-fairing movably secured to move fore and aft when the bogie wheel mounting assembly is adjusted fore and aft. The apex of the vee-fairing defines an aperture to receive the trailing edge of the centerline fairing.

In yet another embodiment of the present invention, a Van Trailer or Chassis comprises one or more generally longitudinal structural beams and bogie wheels attached thereto via a bogie wheel mounting assembly (in the case where this embodiment uses a Chassis, the Chassis can be either of fixed length or telescoping). The longitudinal beam(s) are generally oriented in the direction of travel, and the Van Trailer or Chassis when placed on a road surface defines a spatial gap forward of the bogie wheels between the road surface and the bottom of the Van Trailer or an intermodal container to be carried by the Chassis. The bogie wheel mounting assembly is fore and aft adjustable.

There is also provided in this embodiment a centerline fairing comprising one or more panels secured at a position on or near the longitudinal centerline of the Van Trailer or Chassis, proximate to such gap, and the centerline fairing has a trailing edge. There is additionally provided a vee-fairing having an apex, the vee-fairing having a first section and a second section, each section comprising one or more generally planar panels and each section oriented relative to the other to form a vee, where the vee-fairing is movably secured to move fore and aft when the bogie wheel mounting assembly is adjusted fore and aft.

Additionally in this embodiment, the centerline fairing comprises a first fairing panel (or group of panels) and a second fairing panel (or group of panels), the panels longitudinally juxtapositioned to function aerodynamically as a single panel. A portion of the first fairing panel (or group of panels) is secured to the forward portion of the structural beams, and a portion of the second fairing panel (or group of panels) is secured approximately to the apex of the vee-fairing.

In a further embodiment, there is provided a Chassis comprising one or more generally longitudinal structural beams and bogie wheels attached thereto via a bogie wheel mounting assembly, with the longitudinal beam(s) generally oriented in the direction of travel. The Chassis when placed on a road surface defines a spatial gap forward of the bogie wheels between the road surface and the bottom of an intermodal container to be carried by the Chassis. In addition, the bogie wheel mounting assembly is fore and aft adjustable, and the one or more structural beams each comprises a forward portion and a rearward portion having a telescoping relationship, so that the Chassis has an extendible length. This embodiment further provides a centerline fairing secured at a position on or near the longitudinal centerline of the Chassis, proximate to the spatial gap. The centerline fairing comprises at least two fairing panels, and the panels are longitudinally juxtapositioned to function aerodynamically as a single panel.

Also in this embodiment, a portion of the first fairing panel is secured to the forward portion of the one or more structural beams, a portion of the second fairing panel is slidably mounted to the rearward portion of the one or more structural beams, and the second fairing panel has a trailing edge. Still further, there is provided a vee-fairing having an apex, the vee-fairing having a first section and a second section, each section comprising of one or more generally planar panels and each section oriented relative to the other to form a vee, where the vee-fairing is movably secured to move fore and aft when the bogie wheel mounting assembly is adjusted fore and aft. The trailing edge of the second fairing panel is secured approximately to the apex of the vee-fairing. Optionally, a third fairing panel is provided that is longitudinally juxtaposed with the first and second fairing panels to function aerodynamically as a single panel, with the third fairing panel slidably secured between the first and second fairing panels.

In another embodiment of the present invention, a Chassis comprises one or more generally longitudinal structural beams and bogie wheels attached thereto via a bogie wheel mounting assembly. The longitudinal beam(s) are generally oriented in the direction of travel, and the Chassis when placed on a road surface defines a spatial gap forward of the bogie wheels between the road surface and the bottom of an intermodal container to be carried by the Chassis. The bogie wheel mounting assembly is fore and aft adjustable, and the one or more structural beams each comprises a forward portion and a rearward portion having a telescoping relationship, so that the Chassis has an extendible length.

This embodiment further provides a centerline fairing that is secured at a position on or near the longitudinal centerline of the Chassis, proximate to the spatial gap. The centerline fairing comprises at least two fairing panels, the panels longitudinally juxtapositioned to function aerodynamically as a single panel. A portion of the first fairing panel is secured to the forward portion of the one or more structural beams, a portion of the second fairing panel is slidably mounted to the rearward portion of the one or more structural beams, and the second fairing panel has a trailing edge.

In addition, in this embodiment there is a vee-fairing having an apex, the vee-fairing having a first section and a second section, each section comprising one or more generally planar panels and each section oriented relative to the other to form a vee, where the vee-fairing is movably secured to move fore and aft when the bogie wheel mounting assembly is adjusted fore and aft. The apex of the vee-fairing defines an aperture to receive the trailing edge of the centerline fairing. Optionally, there is provided a third fairing panel that is longitudinally juxtaposed with the first and second fairing panels to function aerodynamically as a single panel. The third fairing panel is slidably secured between the first fairing panel and the second fairing panel.

### BRIEF DESCRIPTION OF THE DRAWINGS

FIG. 1A is an isometric view of a two-panel embodiment of the present invention.

FIG. 1B is an isometric view of a three-panel embodiment of the present invention.

FIGS. 2A and 2B are plan views of the two-panel embodiment in contracted and extended configurations, respectively.

FIG. 3 is an isometric view of a slotted vee-fairing embodiment of the present invention.

FIGS. 4A and 4B are plan views of the slotted vee-fairing embodiment, in contracted and extended configurations, respectively.

FIGS. 5A and 5B are plan views of a vee-fairing embodiment secured to the rear fairing panel to move it fore and aft with the movement of the bogie assembly.

### DETAILED DESCRIPTION OF THE PREFERRED EMBODIMENTS

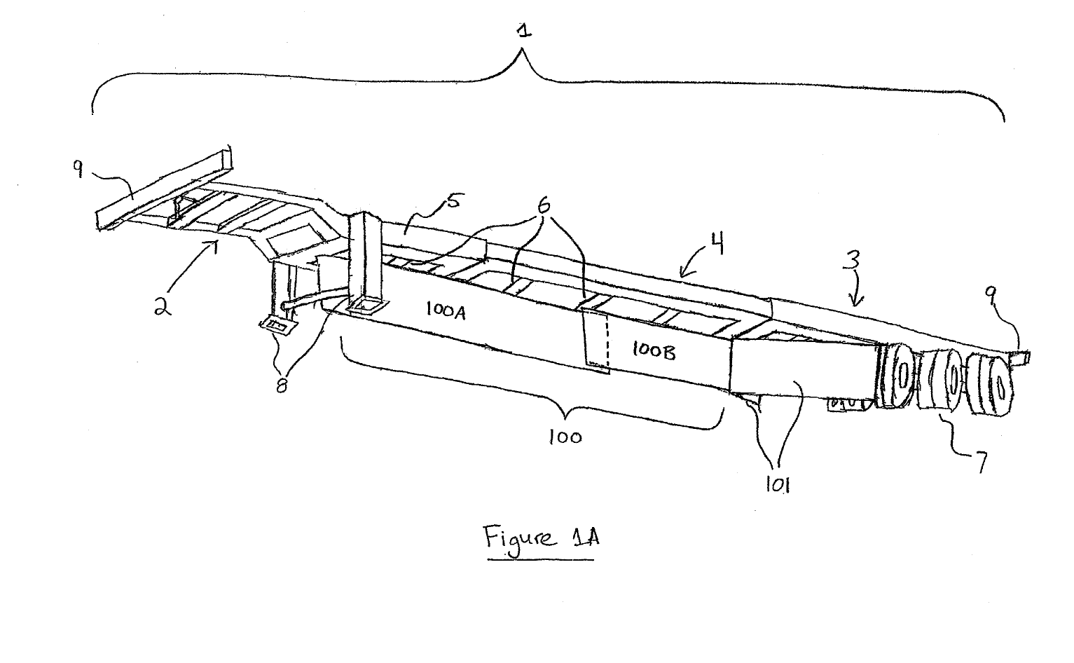

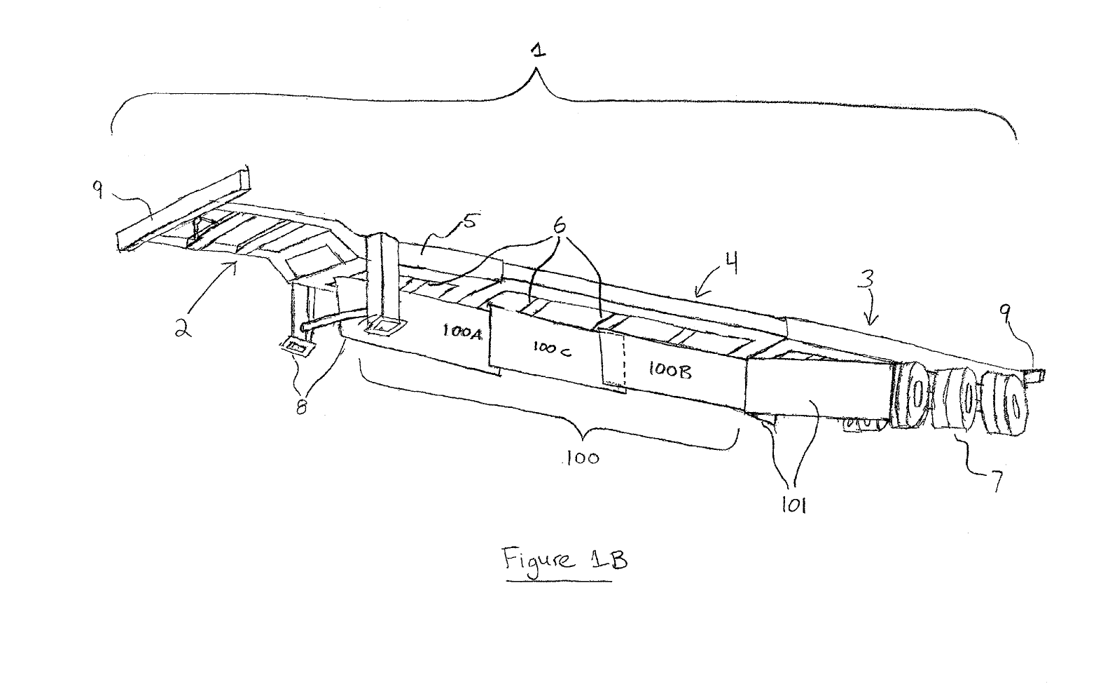

FIG. 1A depicts an isometric view of the undercarriage of an intermodal Chassis with a centerline fairing system according to the invention herein. In particular, FIG. 1A depicts Chassis 1, which generally comprises a front chassis portion 2 and a rear portion chassis 3. In this embodiment, Chassis 1 is for intermodal use and is adjustable in length, in order to accommodate containers of different lengths. To adjust the length, the after section 4 of front chassis portion 2 slides in a trombone-like manner into the rear chassis portion 3.

Chassis 1 in this embodiment generally comprises two I-beams or C-beams 5 approximately twelve inches deep, spaced apart by plural cross members 6 welded to beams 5. A single, double or triple-axle bogie 7 (a triple-axle bogie is shown) is positioned toward the rear of Chassis 1. A square-legged extendible landing gear 8 is positioned toward the front of Chassis 1, aft of the kingpin to which a heavy duty truck tractor (“Tractor”) can be pivotally secured. Two cross beams 9 are also provided on which a container may rest during transport. Landing gear 8 permits a Chassis to sit level and to allow elevation of the Chassis so that a Tractor (not shown) can be attached to and detached from a Chassis.

FIG. 1A depicts Chassis 1 with a centerline fairing 100 as described herein. Centerline fairing 100 is located on the underside of Chassis 1 approximately longitudinally equidistant from the two beams 5, close to or on the longitudinal centerline of Chassis 1. The purpose of centerline fairing 100 is to reduce drag caused by cross-winds and airflow passing underneath of Chassis 1. In this embodiment, centerline fairing 100 comprises two generally planar vertically oriented panels 100A and 100B. The leading edge of panel 100A is located aft of landing gear 8. When Chassis 1 is fully extended, the trailing edge of panel 100A is located approximately at the leading edge of panel 100B, or overlaps it. In turn, the trailing edge of panel 100B is positioned at the apex of vee-fairing 101, also depicted in FIG. 1A. Panels 100A and 100B are closely juxtapositioned in order to function, from an aerodynamic standpoint, as a single panel.

The function of vee-fairing 101 is to reduce drag by reducing airflow into and through bogie 7, and smoothly deflecting it. The vee-fairing 101 is secured forward of bogie 7. Vee-fairing 101 preferably comprises a first section and second section, where each section preferably comprises a generally planar panel and each section is oriented relative to the other to form a vee, although more than two panels can be utilized, for example, better to accommodate particular Chassis designs, bogie wheel assemblies and/or associated appurtenances. While the first and second sections of vee-fairing 101 preferably are generally planar, they can also be made shaped or curved in accordance with design considerations. The angle subtended by the vee likewise can vary in accordance with design considerations, for example 62 degrees or 94 degrees in two currently contemplated configurations.

The apex of vee-fairing 101 in this embodiment is joined to the trailing edge of panel 100B. Vee-fairing 101 further can be rigidly fastened to the underside of Chassis 1, for example to beams 5 and/or plural cross members 6 as by welding, or by one or more metal angle fasteners, bolted or riveted to cross members 6, or by other suitable means. Vee-fairing 101 can also be supported by the mounting assembly of bogie 7. Optionally, vee-fairing 101 can be supported by the mounting assembly of bogie 7 in a cantilevered manner; i.e., rigidly fastened to the mounting assembly of the bogie 7 and not otherwise fastened to the underside of Chassis 1.

In FIG. 1A, the top of fairing panel 100B is rigidly fastened to cross members 6, as by welding, or by one or more 90 degree metal angle fasteners, bolted or riveted to cross members 6, or by other suitable means. The forward portion of fairing panel 100A can be rigidly fastened to one or more cross members 6 of front chassis portion 2, and the rear portion can be slidably fastened to one or more cross members 6 of rear chassis portion 3. Slidable fastening can be accomplished, for example, by slidably securing the rear portion of fairing panel 100A to a rail or similar linear member oriented in a generally longitudinal orientation and secured to one or more cross members 6, where the desired sliding action is obtained by utilizing roller wheels, low friction slide bearings or the like attached to fairing panel 100A, which then roll, slide or otherwise are displaceable along the direction of travel.

Fairing panel 100A can also be slidably attached to the side of fairing panel 100B, depending upon the exact design of Chassis 1. A means for slidably attaching fairing panels 100A and 100B is disclosed in U.S. Pat. No. 7,942,466, issued May 17, 2011, the contents of which are incorporated by reference herein with respect to the referenced means.

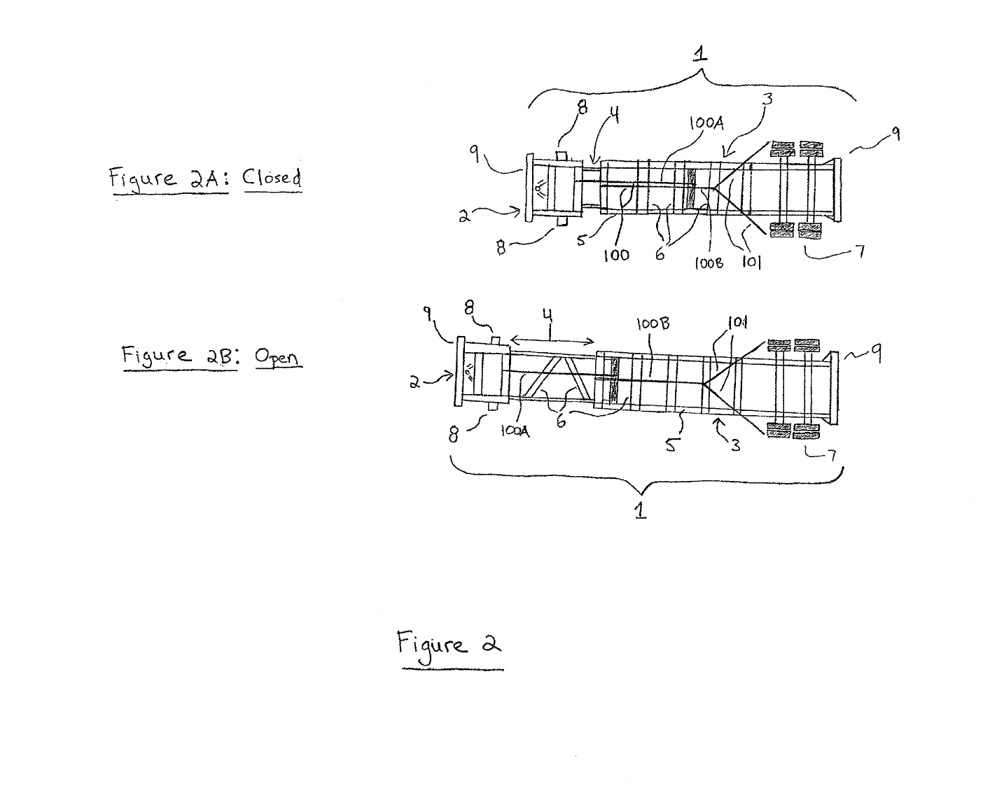

The embodiment of FIG. 1A permits centerline fairing 100 to extend and retract in length, with the adjustment of the length of an intermodal Chassis 1, yet retain its desired aerodynamic properties. FIG. 2 portrays the undercarriage of intermodal Chassis 1 in its extended and shortened configurations. In particular, FIG. 2A depicts Chassis 1 in its shortened position, whereby panel 100A overlaps panel 100B to a substantial degree. In comparison, in FIG. 2B Chassis 1 is in its extended configuration to accommodate larger containers. In this configuration, as Chassis 1 is extended, slidable chassis portion 4 telescopes out of rear chassis portion 3, and panel 100A correspondingly moves along the side of fairing panel 100B to its fully extended position. This configuration allows for the fairing system to be easily and quickly adjusted as Chassis 1 is extended or contracted. Further, the location of fairing 100, approximately near the centerline or middle of Chassis 1, allows a container to be placed on a Chassis freely and quickly, without potentially damaging fairing 100.

FIG. 1B depicts another embodiment of the present invention, particularly adapted to those Chasses which can extend and contract substantial lengths, such as from forty feet to fifty three feet. In FIG. 1 B, centerline fairing 100 comprises three vertical panels 100A, 100B and 100C. The leading edge of panel 100A is located aft of landing gear 8. When Chassis 1 is fully extended, the trailing edge of panel 100A is located approximately at the leading edge of panel 100C, or overlaps it somewhat. In turn, the trailing edge of panel 100C is positioned so that when Chassis 1 is fully extended, it is approximately at the leading edge of panel 100B, or overlaps it somewhat. The trailing edge of panel 100B is positioned at the apex of vee-fairing 101. Panels 100A, 100B and 100C are longitudinally closely juxtapositioned in order to function, from an aerodynamic standpoint, as a single panel.

In the embodiment of FIG. 1B, the top of each of fairing panel 100B and vee-fairing 101 is rigidly fastened to cross members 6, as by welding, or by one or more metal or other fasteners, bolted, riveted or otherwise affixed to cross members 6, or by other suitable means. The forward portion of fairing panel 100A is rigidly fastened to one or more cross members 6 of front chassis portion 2, and the rear portion can be slidably fastened to one or more cross members 6, in the manner described in connection with FIG. 1A. Fairing panel 100C can be slidably attached to the side of fairing panel 100B and/or panel 100A and/or the underside of rear chassis portion 3, in accordance with design preference. The embodiment of FIG. 1B can further be utilized in four or more fairing panel arrangements. More generally, in the foregoing embodiments and elsewhere in this disclosure panels 100A, 100B and 100C can be regarded as functional designations, where each of the panels 100A, 100B and 100C may comprise a group of two or more panels.

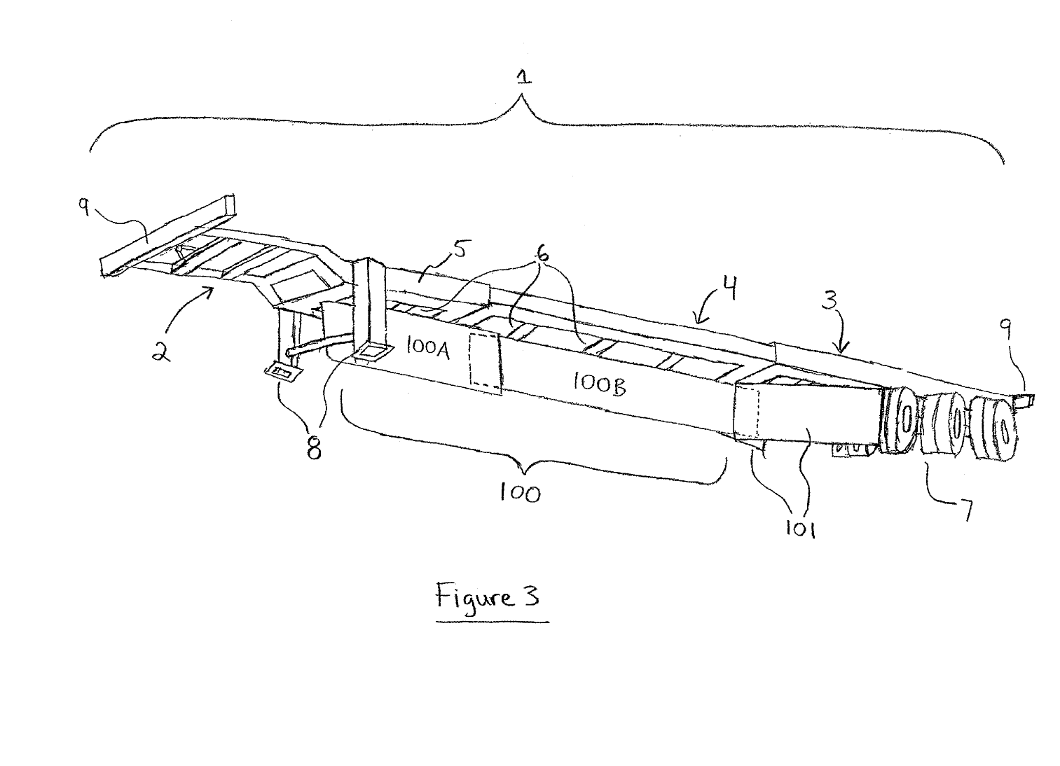

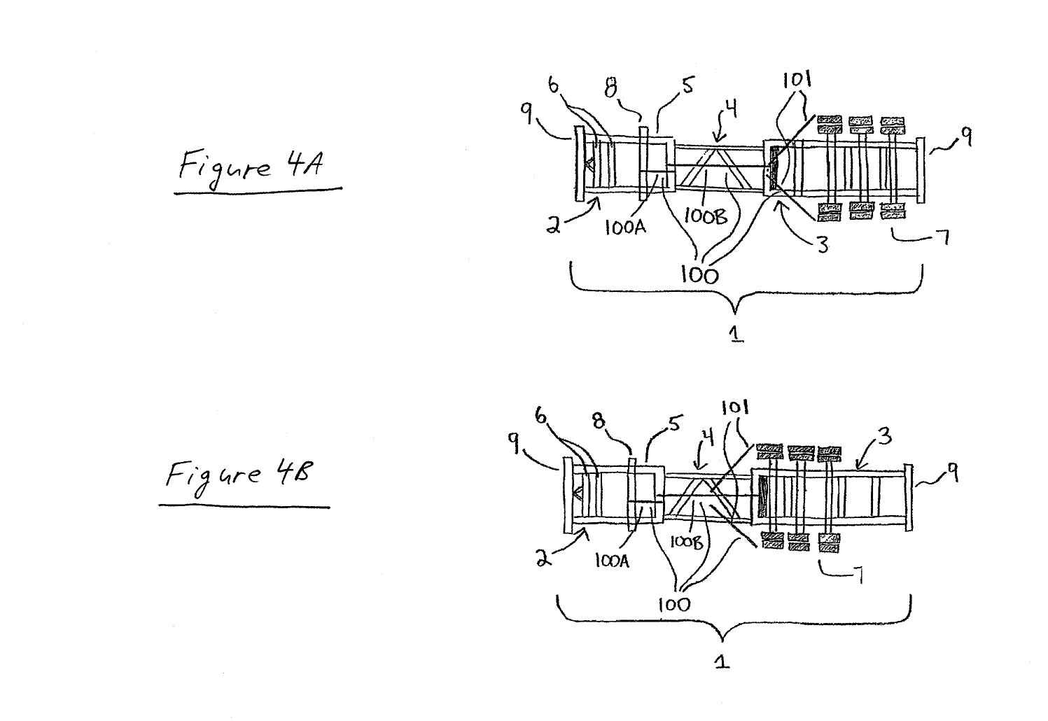

Another embodiment of the centerline fairing system described herein is portrayed in FIGS. 3 and 4. This embodiment is particularly suitable for where the position of bogie 7 on the Chassis 1 is adjustable fore-and-aft. In this embodiment, the sections of vee-fairing 101 are not joined at their apex, but rather are spaced-apart to form a slot that receives the trailing edge of fairing panel 100B. In addition, vee-fairing 101 in this embodiment is not secured to the underside of Chassis 1, but rather is secured to the mounting assembly of bogie 7 in a cantilevered manner. As bogie 7 is moved fore and aft, according to the load, vee-fairing 101 will do so also, and thereby will maintain a proper aerodynamic relation with fairing panel 100B.

FIGS. 4A and 4B portrays the embodiment of FIG. 3 with the bogie 7 in its rear-most (FIG. 4A) and forward-most (FIG. 4B) positions. As shown by FIG. 4A, when bogie 7 is in its rear-most position, vee-fairing 101 is likewise in its rear-most position, and fairing panel 100B is almost entirely exposed. Correspondingly, when bogie 7 is in its forward-most position, as shown in FIG. 4B, vee-fairing 101 is likewise in their forward-most position, with a portion of fairing panel 100B having been received through the slot at the apex of vee-fairing 101 to be nested between the sections of vee-fairing 101. Again, this configuration allows for the fairing system 1 to automatically adjust as bogie 7 is repositioned.

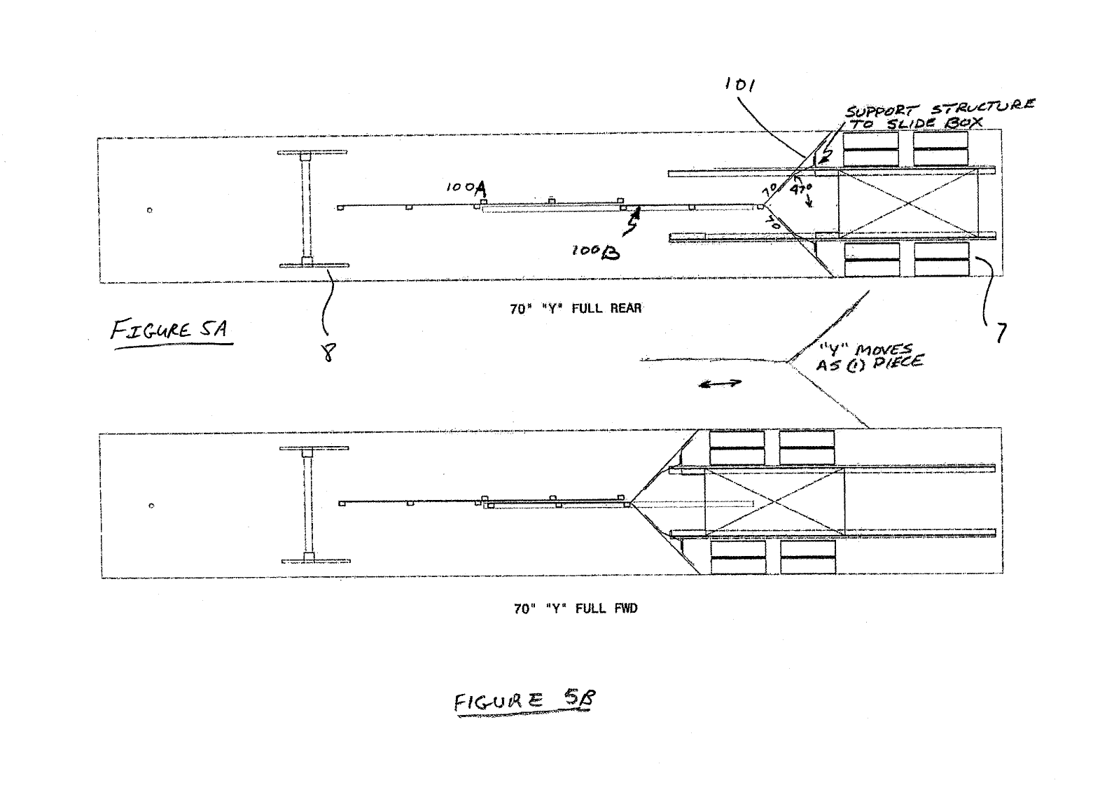

Alternatively, it is possible to accommodate movement of bogie 7 in the manner shown in FIGS. 5A and 5B, which depict an underside view of Chassis 1. In this embodiment, whose principal components are the same as depicted in FIG. 1A, fairing panel 100B is slidably mounted to the underside of Chassis 1 and/or to fairing panel 100A, and the trailing edge of panel 100B is secured to the apex of vee-fairing 101. Vee-fairing 101 is not secured to the underside of Chassis 1, but rather is secured to the mounting assembly of bogie 7 in a cantilevered manner. As a result, as bogie 7 is moved fore and aft according to the load, vee-fairing 101 and fairing panel 100B move together as a unit. This embodiment can also be utilized with three or more panels, where one or more are slidably mounted in addition to panel 100B.

In the preferred embodiments portrayed by FIGS. 1-4, centerline fairing 100 and the panels of vee-fairing 101 generally comprise rectangular planar structures extending in the vertical direction downward to a relatively small distance above the road surface. In one embodiment, approximately 8 inches of clearance is left between the bottoms of fairings 100 and 101 and the road.

The centerline fairing system described herein, although particularly suitable for use with intermodal Chasses, can also be used with Van Trailers. In addition, the various embodiments described herein can be utilized in combination, as desired. For example, the slotted vee-panel embodiment of FIG. 3 can be used with the three panel embodiment of FIG. 1B, to allow for fore-and-aft adjustment of bogie 7 for the three-panel embodiment. Likewise, for those Chasses in which the bogie 7 is fixed in position, the slotted vee-fairing embodiment of FIG. 3 can nonetheless be utilized if it is desired to make panel 100B slidable for-and aft, for example to lessen or eliminate the need for a third panel as in FIG. 3. Other examples will be apparent to the person of ordinary skill based upon this disclosure.

What is claimed is:

1. A chassis comprising:
one or more generally longitudinal structural beams and bogie wheels attached thereto, either directly, or indirectly via a bogie wheel mounting assembly, the longitudinal beam(s) generally oriented in the direction of travel, and the chassis when placed on a road surface defining a spatial gap forward of the bogie wheels between the road surface and the bottom of an intermodal container to be carried by the chassis;
the one or more structural beams each comprising a forward portion and a rearward portion having a telescoping relationship, so that the chassis has an extendible length;
a centerline fairing secured at a position on or near the longitudinal centerline of the chassis, proximate to such gap;
the centerline fairing comprising two or more fairing panels, the panels longitudinally juxtapositioned to function aerodynamically as a single panel;
a first fairing panel of the two or more fairing panels being forward of a second of the two or more fairing panels, a portion of the first fairing panel secured to the forward portion of the one or more structural beams, and a portion of the second fairing panel secured to the rearward portion of the one or more structural beams.

2. A van trailer or chassis comprising:
one or more generally longitudinal structural beams and bogie wheels attached thereto via a bogie wheel mounting assembly, the longitudinal beam(s) generally oriented in the direction of travel, and the van trailer or chassis when placed on a road surface defining a spatial gap forward of the bogie wheels between the road surface and the bottom of the van trailer or an intermodal container to be carried by the chassis;
the bogie wheel mounting assembly being fore and aft adjustable;
a centerline fairing secured at a position on or near the longitudinal centerline of the chassis, proximate to such gap;
the centerline fairing comprising two or more fairing panels, the panels longitudinally juxtapositioned to function aerodynamically as a single panel;
a first fairing panel of the two or more fairing panels being forward of a second of the two or more fairing panels, a portion of the first fairing panel secured to the forward portion of the one or more structural beams, and a portion of the second fairing panel secured to the bogie wheel mounting assembly.

3. A van trailer or chassis comprising:
one or more generally longitudinal structural beams and bogie wheels attached thereto, either directly, or indirectly via a bogie wheel mounting assembly, the longitudinal beam(s) generally oriented in the direction of travel, and the van trailer or chassis when placed on a road surface defining a spatial gap forward of the bogie wheels between the road surface and the bottom of the van trailer or an intermodal container to be carried by the chassis;
a centerline fairing secured at a position on or near the longitudinal centerline of the van trailer or chassis, proximate to such gap, the centerline fairing having a trailing edge;
the centerline fairing comprising one or more longitudinally positioned generally planar panels that are juxtapositioned to function aerodynamically as a single panel;
a vee-fairing having an apex, the vee-fairing having a first section and a section, each section comprising one or more generally planar panels and each section oriented relative to the other to form a vee, the vee-fairing secured forward of the bogie wheels, the apex of the vee-fairing proximate to the trailing edge of the centerline fairing.

4. A chassis comprising:
one or more generally longitudinal structural beams and bogie wheels attached thereto, either directly, or indirectly via a bogie wheel mounting assembly, the longitudinal beam(s) generally oriented in the direction of travel, and the chassis when placed on a road surface defining a spatial gap forward of the bogie wheels between the road surface and the bottom of an intermodal container to be carried by the chassis;
the one or more structural beams each comprising a forward portion and a rearward portion having a telescoping relationship, so that the chassis has an extendible length;
a centerline fairing secured at a position on or near the longitudinal centerline of the chassis, proximate to such gap;
the centerline fairing comprising a first fairing panel, a second fairing panel and a third or more fairing panels, the panels longitudinally juxtapositioned to function aerodynamically as a single panel;
a portion of the first fairing panel secured to the forward portion of the one or more structural beams, a portion of the second fairing panel secured to the rearward portion of the one or more structural beams, and the third or more fairing panels slidably secured between the first fairing panel and the second fairing panel.

5. A van trailer or chassis comprising:
one or more generally longitudinal structural beams and bogie wheels attached thereto via a bogie wheel mounting assembly, the longitudinal beam(s) generally oriented in the direction of travel, and the van trailer or chassis when placed on a road surface defining a spatial gap forward of the bogie wheels between the road surface and the bottom of the van trailer or an intermodal container to be carried by the chassis;
the bogie wheel mounting assembly being fore and aft adjustable;
a centerline fairing comprising one or more panels secured at a position on or near the longitudinal centerline of the van trailer or chassis, proximate to such gap, the centerline fairing having a trailing edge;
a vee-fairing having an apex, the vee-fairing having a first section and a second section, each section comprising one or more panels and each section oriented relative to the other to form a vee; the apex of the vee-fairing defining an aperture to receive the trailing edge of the centerline fairing.

6. A van trailer or chassis comprising:
one or more generally longitudinal structural beams and bogie wheels attached thereto via a bogie wheel mounting assembly, the longitudinal beam(s) generally oriented in the direction of travel, and the van trailer or chassis when placed on a road surface defining a spatial gap forward of the bogie wheels between the road surface and the bottom of the van trailer or an intermodal container to be carried by the chassis;
the bogie wheel mounting assembly being fore and aft adjustable;
a centerline fairing secured at a position on or near the longitudinal centerline of the van trailer or chassis, proximate to such gap, the centerline fairing having a trailing edge;
a vee-fairing having an apex, the vee-fairing having a first section and a second section, each section comprising one or more panels and each section oriented relative to the other to form a vee, the vee-fairing movably secured to move fore and aft when the bogie wheel mounting assembly is adjusted fore and aft;
the centerline fairing comprising a first fairing panel or a first group of panels, and a second fairing panel or second group of panels, the panels longitudinally juxtapositioned to function aerodynamically as a single panel;
a portion of the first fairing panel or group of panels secured to the forward portion of the one or more structural beams, and a portion of the second fairing panel or one of the second group of panels secured approximately to the apex of the vee-fairing.

7. A chassis comprising:
one or more generally longitudinal structural beams and bogie wheels attached thereto via a bogie wheel mounting assembly, the longitudinal beam(s) generally oriented in the direction of travel, and the chassis when placed on a road surface defining a spatial gap forward of the bogie wheels between the road surface and the bottom of an intermodal container to be carried by the chassis;
the bogie wheel mounting assembly being fore and aft adjustable;
the one or more structural beams each comprising a forward portion and a rearward portion having a telescoping relationship, so that the chassis has an extendible length;
a centerline fairing secured at a position on or near the longitudinal centerline of the chassis, proximate to such gap; the centerline fairing comprising at least two fairing panels, the panels longitudinally juxtapositioned to function aerodynamically as a single panel;
a portion of the first fairing panel secured to the forward portion of the one or more structural beams, a portion of the second fairing panel slidably mounted to the rearward portion of the one or more structural beams, the second fairing panel having a trailing edge;
a vee-fairing having an apex, the vee-fairing having a first section and a section, each section comprising one or more panels and each section oriented relative to the other to form a vee, the vee-fairing movably secured to move fore and aft when the bogie wheel mounting assembly is adjusted fore and aft;
the trailing edge of the second fairing panel secured approximately to the apex of the vee-fairing.

8. The chassis of claim 7, further comprising a third or more fairing panels longitudinally juxtapositioned with the first fairing panel and second fairing panel to function aerodynamically as a single panel, the third or more fairing panels slidably secured between the first fairing panel and the second fairing panel.

9. A chassis comprising:
one or more generally longitudinal structural beams and bogie wheels attached thereto via a bogie wheel mounting assembly, the longitudinal beam(s) generally oriented in the direction of travel, and the chassis when placed on a road surface defining a spatial gap forward of the bogie wheels between the road surface and the bottom of an intermodal container to be carried by the chassis;
the bogie wheel mounting assembly being fore and aft adjustable;
the one or more structural beams each comprising a forward portion and a rearward portion having a telescoping relationship, so that the chassis has an extendible length;
a centerline fairing secured at a position on or near the longitudinal centerline of the chassis, proximate to such gap; the centerline fairing comprising at least two fairing panels, the panels longitudinally juxtapositioned to function aerodynamically as a single panel;
a portion of the first fairing panel secured to the forward portion of the one or more structural beams, a portion of the second fairing panel slidably mounted to the rearward portion of the one or more structural beams, the second fairing panel having a trailing edge;
a vee-fairing having an apex, the vee-fairing having a first section and a section, each section comprising one or more panels and each section oriented relative to the other to form a vee, the vee-fairing movably secured to move fore and aft when the bogie wheel mounting assembly is adjusted fore and aft; the apex of the vee fairing defining an aperture to receive the trailing edge of the centerline fairing.

10. The chassis of claim 9, further comprising a third fairing panel longitudinally juxtapositioned with the first fairing panel and second fairing panel to function aerodynamically as a single panel, the third fairing panel slidably secured between the first fairing panel and the second fairing panel.
